(19) United States
(12) Patent Application Publication
(10) Pub. No.: US 2026/0025753 A1
(43) Pub. Date: Jan. 22, 2026

(54) Determining a Central Node for Reporting Sensor Data

(71) Applicant: Google LLC, Mountain View, CA (US)

(72) Inventor: Dongeek Shin, San Jose, CA (US)

(73) Assignee: Google LLC, Mountain View, CA (US)

(21) Appl. No.: 18/998,509

(22) PCT Filed: Jul. 12, 2023
(86) PCT No.: PCT/US2023/070058

§ 371 Date: Jan. 26, 2025

(51) Int. Cl. H04W 48/20; H04L 12/28; H04L 41/12

(52) U.S. Cl. CPC H04W 48/20; H04L 12/2825; H04L 41/12; H04L 2012/2841

(57) ABSTRACT

Techniques and devices for determining a central node for reporting sensor data are described for an electronic device that inserts ranges between nodes in the wireless network into a Euclidean distance matrix (EDM) and decodes the EDM to generate a global topology for the nodes in the wireless network. The electronic device sums, for each node in the wireless network, events detected by each node during a predetermined time period and performs a kernel density filtering of the sums of the detected events over a two-dimensional space of the global topology. The electronic device calculates a product of Gaussian distributions calculated during the kernel density filtering and selects the node that is spatially closest to a peak of the product of Gaussian distributions as the central node for event reporting.

### BACKGROUND

Using wireless networking to connect devices to each other, and to cloud-based services, is increasingly popular for sensing environmental conditions, controlling equipment, and providing information and alerts to users. Many devices on wireless networks are designed to operate for extended periods of time on battery-power, which limits the available computing, user interface, and radio resources in the devices.

Various ambient computing applications use multiple devices to understand spatial context about structures and occupants of the structure to make higher-level decisions. For example, in a home security system, a network of motion sensors aggregates motion detection results and sends them to a cloud service so that a user can have real-time access to the information on a smartphone application. In some networks, each node performs the necessary sensing and reports events to the cloud service. However, there are opportunities to improve device power efficiency (e.g., battery life) in reporting data to cloud services.

### SUMMARY

In aspects, methods, devices, systems, and means for determining a central node for event reporting in a wireless network are described in which an electronic device inserts ranges between nodes in the wireless network into a Euclidean distance matrix (EDM) and decodes the EDM to generate a global topology for the nodes in the wireless network. The electronic device sums, for each node in the wireless network, events detected by each node during a predetermined time period and performs a kernel density filtering of the sums of the detected events over a two-dimensional space of the global topology. The electronic device calculates a product of Gaussian distributions calculated during the kernel density filtering and selects the node that is spatially closest to a peak of the product of Gaussian distributions as the central node for event reporting.

The details of one or more implementations are set forth in the accompanying drawings and the following description. Other features and advantages will be apparent from the description and drawings and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

Aspects of determining a central node for reporting sensor data are described with reference to the following drawings. The same numbers are used throughout the drawings to reference like features and components:

FIG. 1 illustrates an example network environment in which various aspects of determining a central node for reporting sensor data can be implemented.

FIG. 2 illustrates an example an example home area network system in which various aspects of determining a central node for reporting sensor data can be implemented.

FIGS. 3a and 3b illustrate examples of performing ranging between nodes in accordance with aspects of determining a central node for reporting sensor data.

FIGS. 4a and 4b illustrate examples of determining a central node in accordance with aspects of determining a central node for reporting sensor data.

FIG. 5 illustrates an example method of determining a central node for reporting sensor data as in accordance with aspects of the techniques described herein.

FIG. 6 illustrates an example environment in which a home area network can be implemented in accordance with aspects of the techniques described herein.

FIG. 7 illustrates an example wireless network device that can be implemented in a home area network environment in accordance with one or more aspects of the techniques described herein.

FIG. 8 illustrates an example system with an example device that can implement aspects of determining a central node for reporting sensor data.

### DETAILED DESCRIPTION

This document describes techniques and devices to determine a central node in a wireless network (e.g., a Matter network, a Thread network, a Weave network, or the like) for reporting data (sensor measurements, events) to cloud-based systems. In aspects, a framework that allows for a single-reporting system for multiple devices uses a local positioning technique based on Euclidean distance matrices to determine a central node within a cluster (e.g., mesh network) of responding nodes. Each node in the network performs sensing and/or event detection and passes the results to the central node through a low-power local network that in turn forwards the sensor and/or event data to a cloud service. By removing the task of reporting updates from all the nodes except the central node, power-efficiency is improved.

### Example Environment

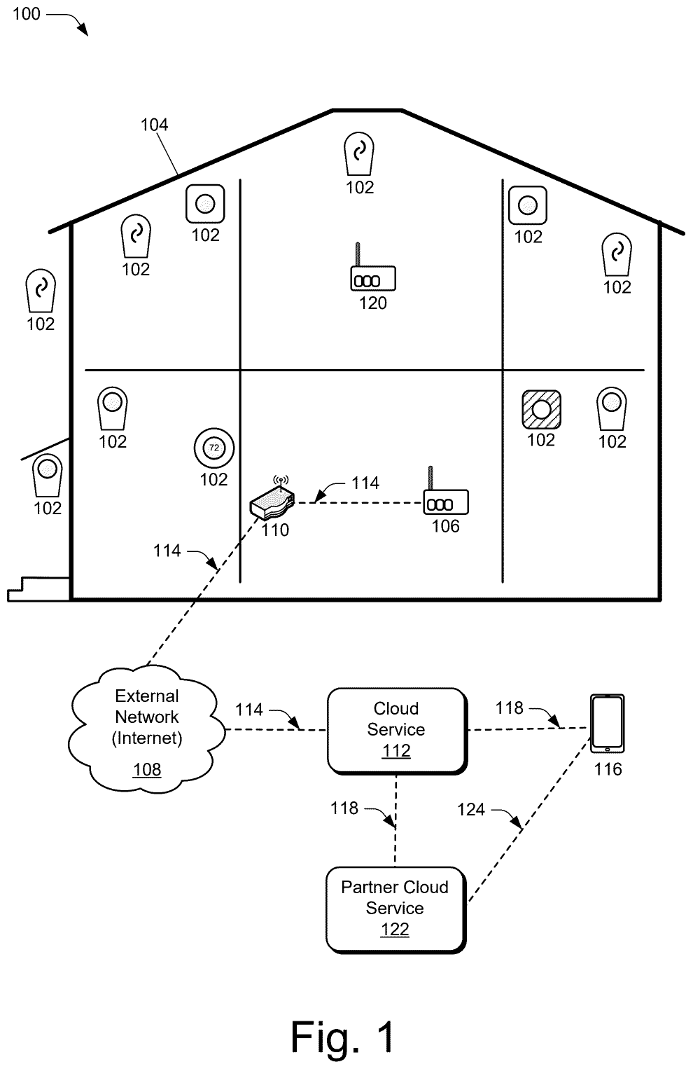

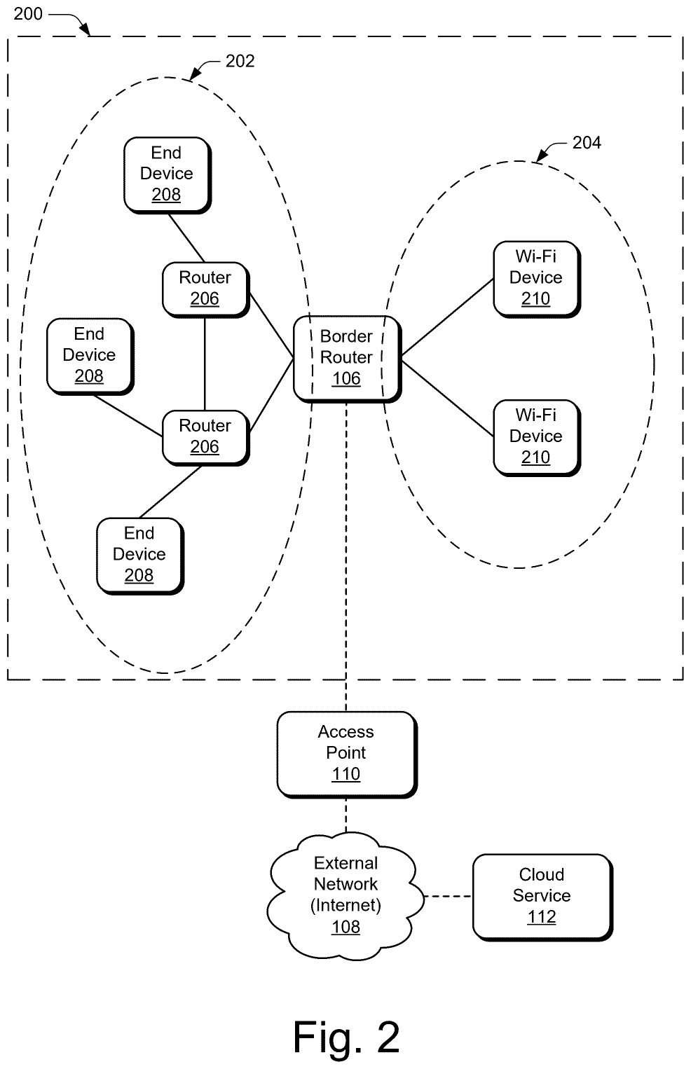

FIG. 1 illustrates an example network environment 100 in which aspects of determining a central node for reporting sensor data can be implemented. The network environment 100 includes a home area network (HAN) such as a HAN 200, described below with respect to FIG. 2. The HAN includes wireless network devices 102 that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via border router 106, via a secure tunnel 114 through the external network 108 and the access point 110. The cloud service 112 facilitates communication between the HAN and internet clients 116, such as apps on mobile devices, using a web-based application programming interface (API) 118.

The HAN may include one or more wireless network devices 102 that function as a hub 120. The hub 120 may be a general-purpose home automation hub, or an application-specific hub, such as a security hub, an energy management hub, an HVAC hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example home area network system (e.g., Matter network, Weave network, fabric network) in which various aspects of determining a central node for reporting sensor data can be implemented. The home area network (HAN) 200 includes a wireless mesh network 202 (e.g., a Thread network) and a Wi-Fi network 204. The HAN 200 may also include wired network devices (e.g., Ethernet devices) that are omitted from FIG. 2 for the sake of illustration clarity. The wireless mesh network 202 includes routers 206 and end devices 208. The routers 206 and the end devices 208, each include a mesh network interface for communication over the mesh network 202. The routers 206 receive and transmit packet data over the mesh network interface. The routers 206 also route traffic across the mesh network 202. The end devices 208 are devices that can communicate using the mesh network 202, but lack the capability, beyond simply forwarding to its parent router 206, to route traffic in the mesh network 202. For example, a battery-powered sensor is one type of end device 208. The Wi-Fi network 204 includes Wi-Fi devices 210. Each Wi-Fi device 210 includes a Wi-Fi network interface for communication over the Wi-Fi network 204.

The border router 106 is included in the wireless mesh network 202 and is included in the Wi-Fi network 204. The border router 106 includes a mesh network interface for communication over the mesh network 202 and a Wi-Fi network interface for communication over the Wi-Fi network 204. The border router 106 routes packets between devices in the wireless mesh network 202 and the Wi-Fi network 204. The border router 106 also routes packets between devices in the HAN 200 and external network nodes (e.g., the cloud service 112) via the external network 108, such as the Internet, through a home router or access point 110.

The devices in the mesh network 202 and the Wi-Fi network 204 use standard IP routing configurations to communicate with each other through transport protocols such as the User Datagram Protocol (UDP) or the Transmission Control Protocol (TCP). When the devices in the mesh network 202 and the Wi-Fi network 204 are provisioned as part of a Matter network, the devices can communicate messages over those same UDP and/or TCP transports.

### Determining a Central Node for Reporting Sensor Data

In a first aspect of determining a central node for reporting sensor data, ranging is performed between nodes of a wireless network. For example, wireless technologies, such as ultra-wideband (UWB), IEEE 802.11.mc, or ultrasound are used that support direct measurement of range by using measurements such as turn-around time. These techniques provide more accurate ranging measurements than those measured using proxy measurements (e.g., received signal strength indication (RSSI)) that may be affected by signal attenuation of building materials in a structure.

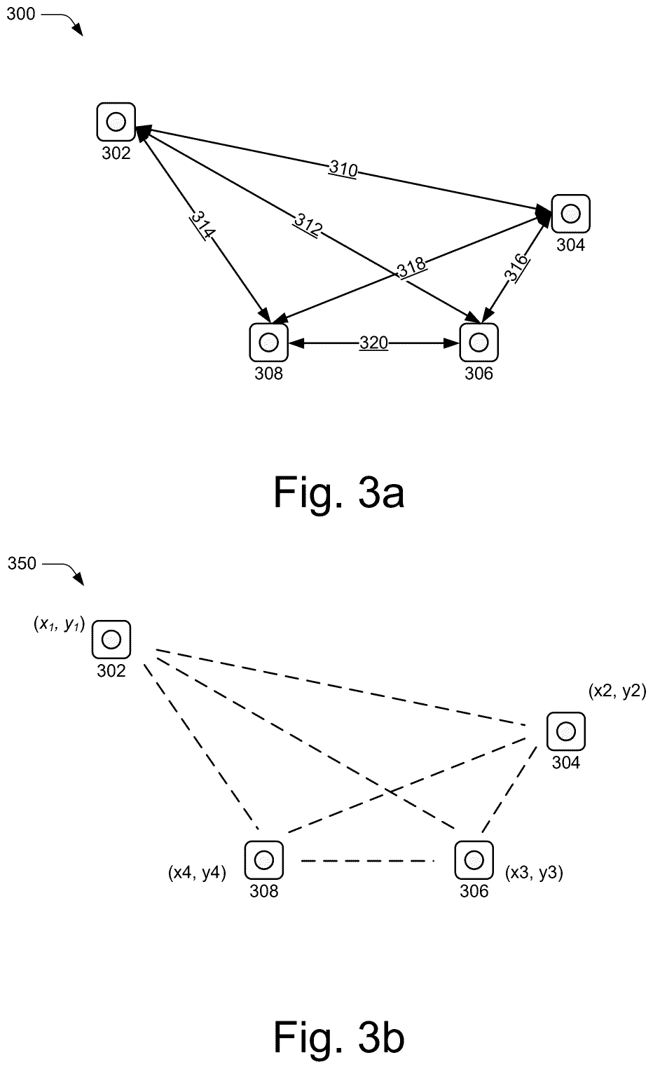

FIG. 3a illustrates ranging between devices with which various aspects of determining a central node for reporting sensor data can be implemented. During a setup time, round-robin ranging is performed between each pair of wireless devices in the network to determine distances between the nodes. For example, node (wireless device) 302 ranges the nodes 304, 306, and 308 at 310, 312, and 314, respectively. The round-robin ranging continues with the node 304 ranging the nodes 306 and 308 at 316 and 318, respectively. The round-robin ranging finishes with node 306 ranging the node 308 at 320. Although the ranging is illustrated with four nodes, any number of nodes in a wireless network can be used.

The turn-around times from the ranging between the nodes are inserted into a Euclidean distance matrix (EDM). For Nnodes, the EDM is formed as a data structure, where the (i, j)-th entry of the EDM equals the squared distance from an i-th node to a j-th node:

$$E D M ( T ) = [ \begin{matrix}0 & {d}_{1 , 2}^{2} & … & {d}_{1 , N}^{2} \\ ⋮ & & ⋱ & ⋮ \\ {d}_{N , 1}^{2} & {d}_{N , 2}^{2} & … & 0\end{matrix} ] \qquad ( 1 )$$

Properties of the EDM include that the EDM is element-wise non-negative because distance values are always non-negative, the EDM is zero diagonal because a distance from anode to itself is always zero, and the EDM is symmetric because the distance from a node A to a node B is the same as from node B to node A. The EDM also has an inverse relationship with device-to-device communication channel fidelity (e.g., the closer two nodes are, the better local, low-noise communication support between the two nodes).

With the ranging data inserted into the EDM, the EDM is used as an input to compute a global topology estimate, T, of the nodes in the wireless network. The global topology estimate, as calculated in the following equations, is used to determine the optimal node for event reporting. Tis computed by:
1. Computing a geometric centering matrix:

$$C = I - \frac{1}{n} 1 {1}^{T} \qquad ( 2 )$$

where I is an identity matrix, n is the number of nodes, 1 is a matrix of ones, and T is the matrix transpose operator, wherein the identity matrix I and the matrix 1 are respectively of the size n×n.
2. Computing a Gram matrix using the geometric centering matrix:

$$G = - 0 \text{.5} CEDM ( T ) C \qquad ( 3 )$$

3. Performing an eigenvalue decomposition of the Gram matrix:

$$U , {[ {λ}_{i} ]}_{i = 1}^{n} = E V D ( G ) \qquad ( 4 )$$

where U is the eigenvector matrix and k is the i-th eigenvalue.
4. Estimate the global topology using the eigenvalue decomposition:

$$T = [ diag ( \sqrt{{λ}_{1}} ) , … , ( \sqrt{{λ}_{d}} ) {0}_{d x ( N - d )} ] {U}^{T} \qquad ( 5 )$$

where diag relates to the creation of a diagonal matrix and d is the Euclidean space dimension (e.g. d=3 for a natural three-dimensional space).
   FIG. 3b illustrates the resulting global topology with coordinates assigned to each of the nodes 302, 304, 306, and 308.

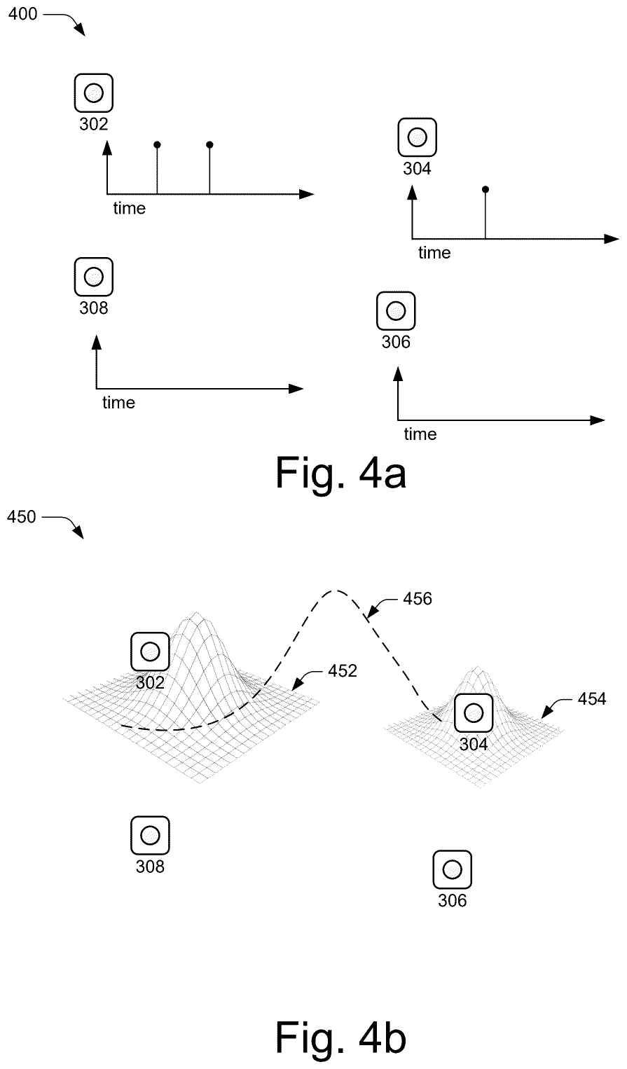

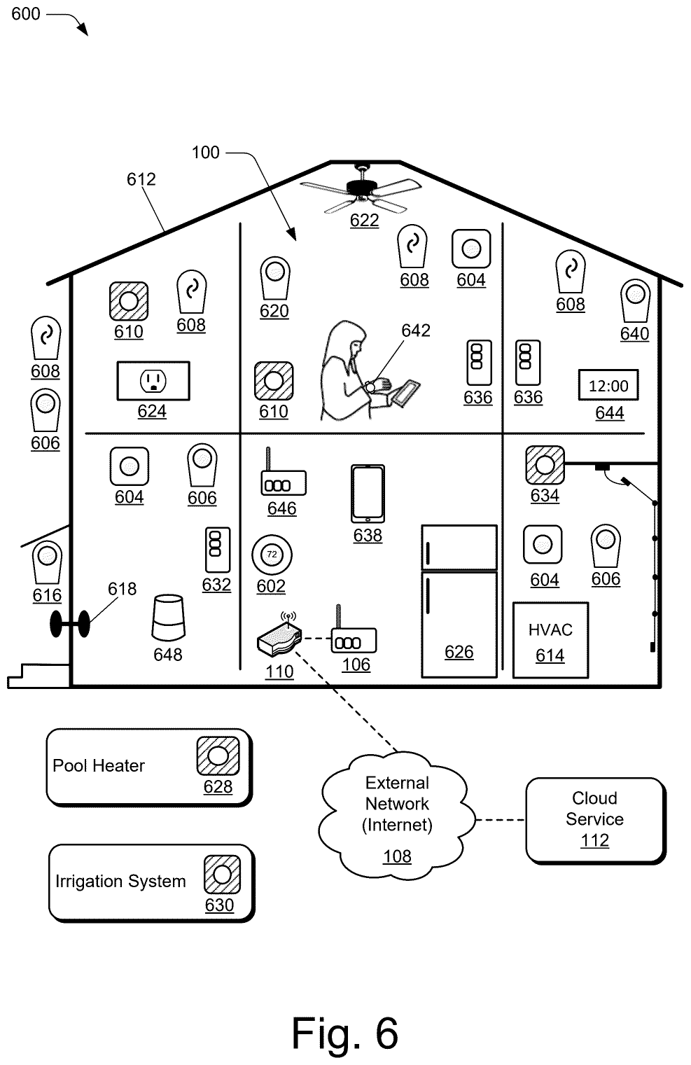

In another aspect of determining a central node for reporting sensor data, events are gathered over a predetermined time period (e.g., an event window, such as a one minute event window) at each node in the wireless network. For example, events include sensor measurements (such as those described below with respect to FIG. 6), triggered events (such as a passive infrared motion detector reporting a motion event), and the like. A data structure for event data across the network may be sparse as some nodes have no events to report. For example, in FIG. 4a, node 302 detects two events (illustrated as the vertical lines terminated with a filled-circle), node 304 detects one event, and nodes 306 and 308 detect no events.

For the nodes with relevant events (nodes 302 and 304), a sum of the detected events is computed. For example, a cloud service, a border router, a hub, a user application on a smartphone, or any suitable device can calculate the sum of the events for each node. A kernel density filtering of the sum of the detected events is performed over the two-dimensional space of the global topology to estimate a spatial event heatmap as illustrated at 450 in FIG. 4b. The kernel density filtering obtains a probability density function. Instead of creating arbitrary bins of data, the density is evaluated at each node, using the distance to neighboring nodes as input to a Gaussian kernel function. The kernel density filtering can assume a Gaussian kernel, where the event count per node can be proportional to the weight of the kernel, as shown at 452 and 454.

To select the central node for event reporting, a product of the Gaussian distributions 452 and 454 is computed. The filtered distributions are taken through a joint product to output a net Gaussian, which can then be used to determine the optimal device location. The product of the Gaussian distributions 452 and 454 is computed using:

$$N ( {μ}_{1} , {σ}_{1}^{2} ) \times N ( {μ}_{2} , {σ}_{2}^{2} ) = N ( \frac{{σ}_{1}^{2} {μ}_{2} + {σ}_{2}^{2} {μ}_{1}}{{σ}_{1}^{2} + {σ}_{2}^{2}} , \frac{1}{\frac{1}{{σ}_{1}^{2}} + \frac{1}{{σ}_{2}^{2}}} ) \qquad ( 6 )$$

where μ is the mean of the respective Gaussian distributions and σ² is the variance of the respective Gaussian distributions
   that results in the product at 456 that is the final spatial map that is used to choose the central node for event reporting. The node that is spatially closest to the peak of the Gaussian product 456 is the node that is selected, by comparing the Euclidean distance between the mode of the Gaussian product with the device node locations, as the central node to report events to the cloud service. Other nodes in the wireless network report their detected events to the selected central node (e.g. node 302) that in turn forwards events to the cloud service.

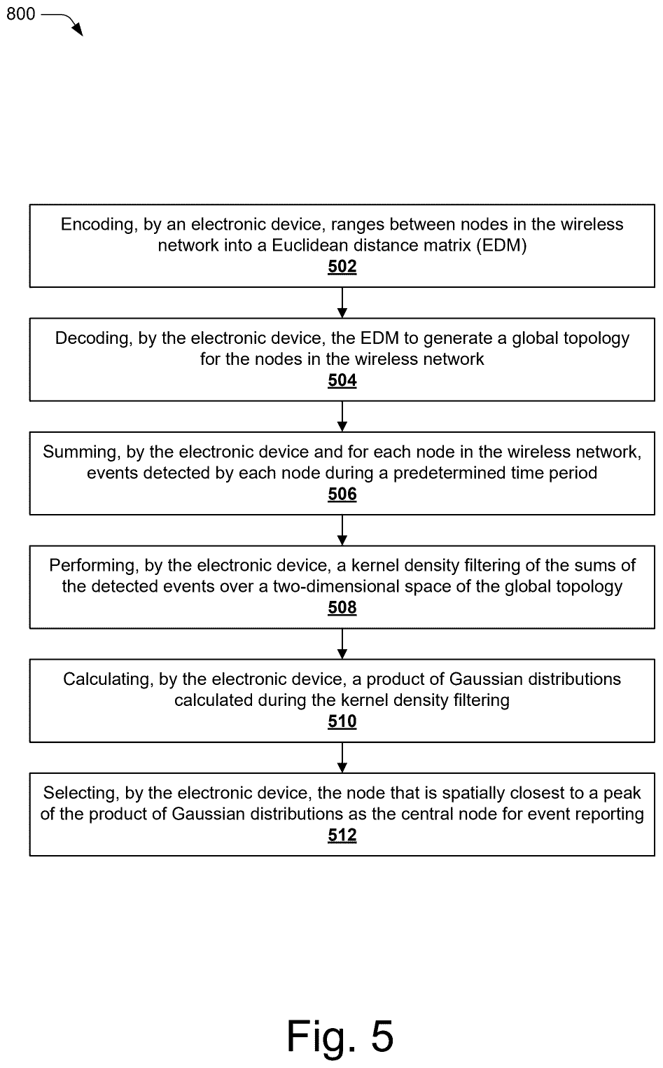

FIG. 5 illustrates example method(s) 500 of determining a central node for reporting sensor data as generally related nodes in a home area network. At block 502, an electronic device inserts ranges between nodes in the wireless network into a Euclidean distance matrix (EDM). For example, an electronic device (e.g., a cloud service 112, a border router 106, a user device 638, a hub 120) inserts ranges between nodes (e.g., nodes 303, 304, 306, and 308) in the wireless network (home area network 200) into a Euclidean distance matrix (EDM) using equation 1.

At block 504, the electronic device decodes the EDM to generate a global topology for the nodes in the wireless network. For example, the electronic device decodes the EDM to generate a global topology for the nodes in the wireless network using equations 2, 3, 4, and 5 as described above.

At block 506, the electronic device sums, for each node in the wireless network, events detected by each node during a predetermined time period. For example, the electronic device sums, for each node in the wireless network, events detected by each node during a predetermined time period (e.g., a one-minute period).

At block 508, the electronic device performs a kernel density filtering of the sums of the detected events over a two-dimensional space of the global topology. For example, the electronic device performs a kernel density filtering of the sums of the detected events over a two-dimensional space of the global topology generated at 504.

At block 510, the electronic device calculates a product of Gaussian distributions calculated during the kernel density filtering. For example, the electronic device calculating, by the electronic device, a product of Gaussian distributions calculated during the kernel density filtering using equation 6.

At block 512, the electronic device selects the node that is spatially closest to a peak of the product of Gaussian distributions as the central node for event reporting. For example, the electronic device selects the node that is spatially closest to a peak of the product of Gaussian distributions as the central node for event reporting to a cloud service (e.g., the cloud service 112).

### Example Environments and Devices

FIG. 6 illustrates an example environment 600 in which a home area network 200, as described with reference to FIGS. 1 and 2, and aspects of determining a central node for reporting sensor data can be implemented. Generally, the environment 600 includes the home area network (HAN) 200 implemented as part of a home or other type of structure with any number of wireless and/or wired network devices that are configured for communication in a wireless network. For example, the wireless network devices can include a thermostat 602, hazard detectors 604 (e.g., for smoke and/or carbon monoxide), cameras 606 (e.g., indoor and outdoor), lighting units 608 (e.g., indoor and outdoor), and any other types of wireless network devices 610 that are implemented inside and/or outside of a structure 612 (e.g., in a home environment). In this example, the wireless network devices can also include any of the previously described devices, such as a border router 106, as well as any of the devices implemented as a router device 206, and/or as an end device 208.

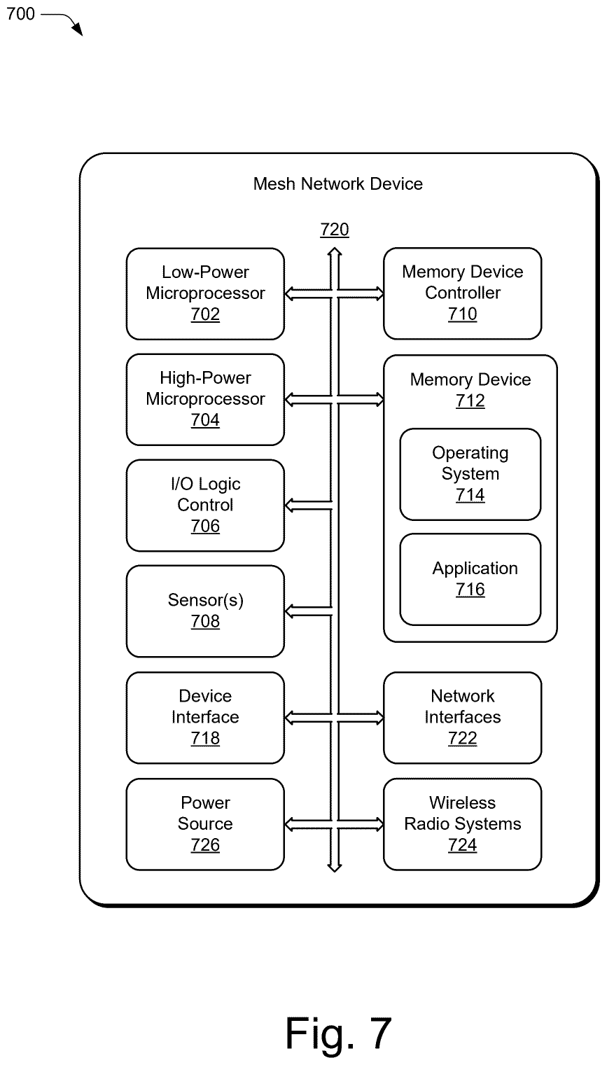

In the environment 600, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 7.

In implementations, the thermostat 602 may include a Nest® Learning Thermostat that detects ambient climate characteristics (e.g., temperature and/or humidity) and controls a HVAC system 614 in the home environment. The learning thermostat 602 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 604 can be implemented to detect the presence of a hazardous substance or a substance indicative of a hazardous substance (e.g., smoke, fire, or carbon monoxide). In examples of wireless interconnection, a hazard detector 604 may detect the presence of smoke, indicating a fire in the structure, in which case the hazard detector that first detects the smoke can broadcast a low-power wake-up signal to all of the connected wireless network devices. The other hazard detectors 604 can then receive the broadcast wake-up signal and initiate a high-power state for hazard detection and to receive wireless communications of alert messages. Further, the lighting units 608 can receive the broadcast wake-up signal and activate in the region of the detected hazard to illuminate and identify the problem area. In another example, the lighting units 608 may activate in one illumination color to indicate a problem area or region in the structure, such as for a detected fire or break-in, and activate in a different illumination color to indicate safe regions and/or escape routes out of the structure.

In various configurations, the wireless network devices 610 can include an entryway interface device 616 that functions in coordination with a network-connected door lock system 618, and that detects and responds to a person's approach to or departure from a location, such as an outer door of the structure 612. The entryway interface device 616 can interact with the other wireless network devices based on whether someone has approached or entered the smart-home environment. An entryway interface device 616 can control doorbell functionality, announce the approach or departure of a person via audio or visual means, and control settings on a security system, such as to activate or deactivate the security system when occupants come and go. The wireless network devices 610 can also include other sensors and detectors, such as to detect ambient lighting conditions, detect room-occupancy states (e.g., with an occupancy sensor 620), and control a power and/or dim state of one or more lights. In some instances, the sensors and/or detectors may also control a power state or speed of a fan, such as a ceiling fan 622. Further, the sensors and/or detectors may detect occupancy in a room or enclosure and control the supply of power to electrical outlets or devices 624, such as if a room or the structure is unoccupied.

The wireless network devices 610 may also include connected appliances and/or controlled systems 626, such as refrigerators, stoves and ovens, washers, dryers, air conditioners, pool heaters 628, irrigation systems 630, security systems 632, and so forth, as well as other electronic and computing devices, such as network-connected televisions, network-connected media streaming devices, entertainment systems, computers, intercom systems, garage-door openers 634, ceiling fans 622, control panels 636, and the like. When plugged in, an appliance, device, or system can announce itself to the home area network as described above and can be automatically integrated with the controls and devices of the home area network, such as in the home. It should be noted that the wireless network devices 610 may include devices physically located outside of the structure, but within wireless communication range, such as a device controlling a swimming pool heater 628 or an irrigation system 630.

As described above, the HAN 200 includes a border router 106 that interfaces for communication with an external network, outside the HAN 200. The border router 106 connects to an access point 110, which connects to the communication network 108, such as the Internet. A cloud service 112, which is connected via the communication network 108, provides services related to and/or using the devices within the HAN 200. By way of example, the cloud service 112 can include applications for connecting end user devices 638, such as smartphones, tablets, and the like, to devices in the home area network, processing and presenting data acquired in the HAN 200 to end users, linking devices in one or more HANs 200 to user accounts of the cloud service 112, provisioning and updating devices in the HAN 200, and so forth. For example, a user can control the thermostat 602 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, UWB, 802.11.mc, etc.) and/or by using any of a variety of custom or standard wired protocols (CAT6 Ethernet, HomePlug, etc.).

Any of the wireless network devices in the HAN 200 can serve as low-power and communication nodes to create the HAN 200 in the home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 640 detects that the room is dark and when the occupancy sensor 620 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (i.e., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 608 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 608 that lead to a safe exit. The light units 608 may also be turned-on to indicate the direction along an exit route that a person should travel to safely exit the structure.

The various wireless network devices may also be implemented to integrate and communicate with wearable computing devices 642, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared orNFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 610 may also include a network-connected alarm clock 644 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 602 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 602 so as to pre-heat or cool the environment to a desired setting and turning-on or turning-off the lights 608.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 600 may include one or more wireless network devices that function as a hub 646. The hub 646 may be a general-purpose home automation hub, or an application-specific hub, such as a security hub, an energy management hub, an HVAC hub, and so forth. The functionality of a hub 646 may also be integrated into any wireless network device, such as a network-connected thermostat device or the border router 106. Hosting functionality on the hub 646 in the structure 612 can improve reliability when the user's internet connection is unreliable, can reduce latency of operations that would normally have to connect to the cloud service 112, and can satisfy system and regulatory constraints around local access between wireless network devices.

Additionally, the example environment 600 includes a network-connected speaker 648. The network-connected speaker 648 provides voice assistant services that include providing voice control and/or commissioning of network-connected devices. The functions of the hub 646 may be hosted in the network-connected speaker 648. The network-connected speaker 648 can be configured to communicate via the wireless mesh network 202, the Wi-Fi network 204, or both.

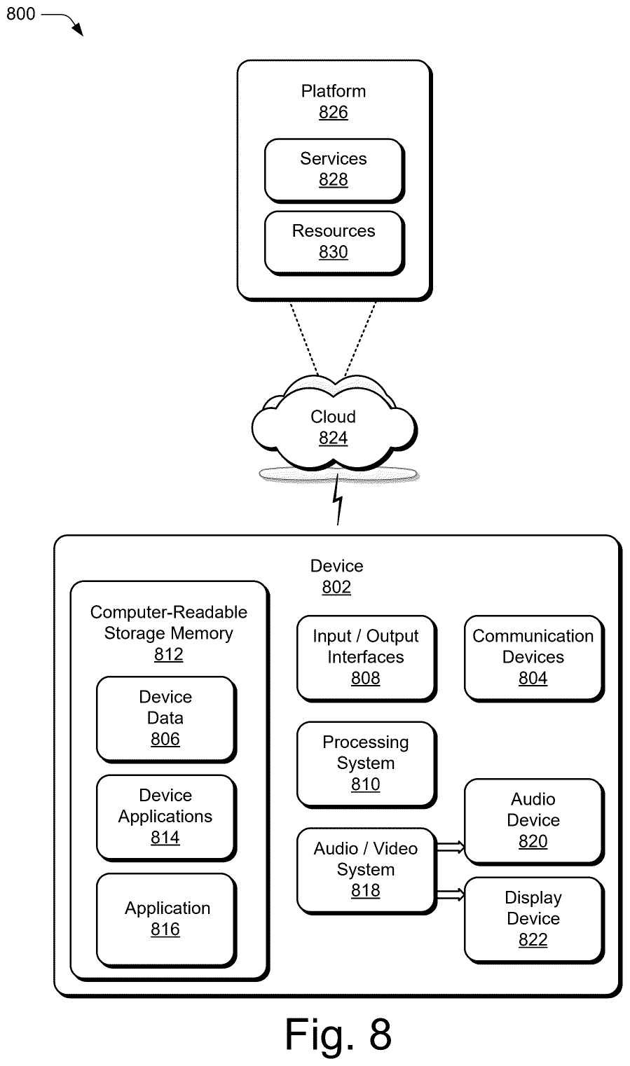

FIG. 7 illustrates an example wireless network device 700 that can be implemented as any of the wireless network devices in a home area network (Weave network) in accordance with one or more aspects of determining a central node for reporting sensor data as described herein. The device 700 can be integrated with electronic circuitry, microprocessors, memory, input output (I/O) logic control, communication interfaces and components, as well as other hardware, firmware, and/or software to implement the device in a home area network. Further, the wireless network device 700 can be implemented with various components, such as with any number and combination of different components as further described with reference to the example device shown in FIG. 8.

In this example, the wireless network device 700 includes a low-power microprocessor 702 and a high-power microprocessor 704 (e.g., microcontrollers or digital signal processors) that process executable instructions. The device also includes an input-output (I/O) logic control 706 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or additionally, the device can be implemented with any one or combination of software, hardware, firmware, or fixed logic circuitry that may be implemented with processing and control circuits. The low-power microprocessor 702 and the high-power microprocessor 704 can also support one or more different device functionalities of the device. For example, the high-power microprocessor 704 may execute computationally intensive operations, whereas the low-power microprocessor 702 may manage less-complex processes such as detecting a hazard or temperature from one or more sensors 708. The low-power processor 702 may also wake or initialize the high-power processor 704 for computationally intensive processes.

The one or more sensors 708 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 708 may include any one or a combination of temperature sensors, humidity sensors, hazard-related sensors, security sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 700 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 700 includes a memory device controller 710 and a memory device 712, such as any type of a nonvolatile memory and/or other suitable electronic data storage device. The wireless network device 700 can also include various firmware and/or software, such as an operating system 714 that is maintained as computer executable instructions by the memory and executed by a microprocessor. The device software may also include an application 716 that implements aspects of determining a central node for reporting sensor data. The wireless network device 700 also includes a device interface 718 to interface with another device or peripheral component and includes an integrated data bus 720 that couples the various components of the wireless network device for data communication between the components. The data bus in the wireless network device may also be implemented as any one or a combination of different bus structures and/or bus architectures.

The device interface 718 may receive input from a user and/or provide information to the user (e.g., as a user interface), and a received input can be used to determine a setting. The device interface 718 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 718 may also receive inputs from any number of peripherals, such as buttons, a keypad, a switch, a microphone, and an imager (e.g., a camera device).

The wireless network device 700 can include network interfaces 722, such as a wireless network interface or home area network interface for communication with other wireless network devices in a home area network, and an external network interface for network communication, such as via the Internet. The wireless network device 700 also includes wireless radio systems 724 for wireless communication with other wireless network devices via the home area network interface and for multiple, different wireless communications systems. The wireless radio systems 724 may include Wi-Fi, Bluetooth™, Mobile Broadband, BLE, Thread, Matter, UWB, IEEE 802.11.mc, and/or point-to-point IEEE 802.15.4. Each of the different radio systems can include a radio device, antenna, and chipset that is implemented for a particular wireless communications technology. The wireless network device 700 also includes a power source 726, such as a battery and/or to connect the device to line voltage. An AC power source may also be used to charge the battery of the device.

FIG. 8 illustrates an example system 800 that includes an example device 802, which can be implemented as any of the wireless network devices that implement aspects of determining a central node for reporting sensor data as described with reference to the previous FIGS. 1-7. The example device 802 may be any type of computing device, client device, mobile phone, tablet, communication, entertainment, gaming, media playback, and/or other type of device. Further, the example device 802 may be implemented as any other type of wireless network device that is configured for communication on a home area network, such as a thermostat, hazard detector, camera, light unit, commissioning device, router, border router, joiner router, joining device, end device, leader, access point, and/or other wireless network devices.

The device 802 includes communication devices 804 that enable wired and/or wireless communication of device data 806, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 804 can also include transceivers for cellular phone communication and/or for network data communication.

The device 802 also includes input/output (I/O) interfaces 808, such as data network interfaces that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 802 includes a processing system 810 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or additionally, the device can be implemented with any one or combination of software, hardware, firmware, or fixed logic circuitry that may be implemented with processing and control circuits. The device 802 may further include any type of a system bus or other data and command transfer system that couples the various components within the device. A system bus can include any one or combination of different bus structures and architectures, as well as control and data lines.

The device 802 also includes computer-readable storage memory 812 (computer-readable storage media), such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 812 provides storage of the device data 806 and various device applications 814, such as an operating system that is maintained as a software application with the computer-readable storage memory and executed by the processing system 810. The device applications may also include a device manager, such as any form of a control application, software application, signal processing and control module, code that is native to a particular device, a hardware abstraction layer for a particular device, and so on. In this example, the device applications also include an application 816 that implements aspects determining a central node for reporting sensor data such as when the example device 802 is implemented as any of the wireless network devices described herein.

The device 802 also includes an audio and/or video system 818 that generates audio data for an audio device 820 and/or generates display data for a display device 822. The audio device and/or the display device include any devices that process, display, and/or otherwise render audio, video, display, and/or image data, such as the image content of a digital photo. In implementations, the audio device and/or the display device are integrated components of the example device 802. Alternatively, the audio device and/or the display device are external, peripheral components to the example device. In aspects, at least part of the techniques described for determining a central node for reporting sensor data may be implemented in a distributed system, such as over a “cloud” 824 in a platform 826. The cloud 824 includes and/or is representative of the platform 826 for services 828 and/or resources 830.

The platform 826 abstracts underlying functionality of hardware, such as server devices (e.g., included in the services 828) and/or software resources (e.g., included as the resources 830), and connects the example device 802 with other devices, servers, etc. For example, the platform 826 and/or the services 828 may implement aspects of determining a central node for reporting sensor data. The resources 830 may also include applications and/or data that can be utilized while computer processing is executed on servers that are remote from the example device 802. Additionally, the services 828 and/or the resources 830 may facilitate subscriber network services, such as over the Internet, a cellular network, or Wi-Fi network. The platform 826 may also serve to abstract and scale resources to service a demand for the resources 830 that are implemented via the platform, such as in an interconnected device aspect with functionality distributed throughout the system 800. For example, the functionality may be implemented in part at the example device 802 as well as via the platform 826 that abstracts the functionality of the cloud 824.

In the following some examples are described:

Example 1: A method for selecting a central node for event reporting in a wireless network, the method comprising:
inserting, by an electronic device, ranges between nodes in the wireless network into a Euclidean distance matrix (EDM);
decoding, by an electronic device, the EDM to generate a global topology for the nodes in the wireless network;
summing, by the electronic device and for each node in the wireless network, events detected by each node during a predetermined time period;
performing, by the electronic device, a kernel density filtering of the sums of the detected events over a two-dimensional space of the global topology;
calculating, by the electronic device, a product of Gaussian distributions calculated by the kernel density filtering; and
selecting the node that is spatially closest to a peak of the product of Gaussian distributions as the central node for event reporting.
   Example 2: The method of example 1, wherein the decoding of the EDM comprises:
generating, by the electronic device, a geometric centering matrix;
generating, by the electronic device, a Gram matrix using the generated geometric centering matrix;
generating, by the electronic device, an eigenvalue decomposition of the generated Gram matrix; and
estimating, by the electronic device, the global topology from the generated eigenvalue decomposition.
   Example 3: The method of example 1 or example 2, wherein the ranges between the nodes are determined by round-robin ranging between the nodes in the wireless network.
   Example 4: The method of example 3, wherein the ranging is determined by measuring turn-around times between each pair of nodes in the wireless network.
   Example 5: The method of example 4, wherein the nodes determine ranges by measuring turn-around times using IEEE 802.11.mc wireless communication or ultra-wideband wireless communication.
   Example 6: The method of example 3, wherein the inserting of the determined ranges between the nodes into a Euclidean distance matrix (EDM) comprises:
inserting, by the electronic device, the measured turn-around times between the nodes into the EDM.
   Example 7: The method of any one of the preceding examples, wherein the selecting the central node is effective to direct nodes in the wireless network to forward detected events to the central node, and wherein the central node forwards the events to a cloud service.
   Example 8: The method of any one of the preceding examples, wherein the kernel for the kernel density filtering of the sums of the detected events is a Gaussian kernel.
   Example 9: The method of any one of the preceding examples, wherein the electronic device is one of
a server for a cloud service;
a border router;
a smartphone; or
a hub.
   Example 10: An apparatus comprising:
a processor; and
instructions executable by the processor to perform a method as recited in any one of examples 1 to 9.
   Example 11: The apparatus of example 10, wherein the apparatus is one of:
a server for a cloud service;
a border router;
a smartphone; or
a hub.
   Example 12: A non-transitory computer-readable storage medium comprising instructions for an application, the instructions executable by one or more processors, to configure the application to perform a method as recited in any one of examples 1 to 9.

Although aspects of determining a central node for reporting sensor data have been described in language specific to features and/or methods, the subject of the appended claims is not necessarily limited to the specific features or methods described. Rather, the specific features and methods are disclosed as example implementations of determining a central node for reporting sensor data and other equivalent features and methods are intended to be within the scope of the appended claims. Further, various different aspects are described, and it is to be appreciated that each described aspect can be implemented independently or in connection with one or more other described aspects.

1. A method for selecting a central node for event reporting in a wireless network, the method comprising:
inserting, by an electronic device, ranges between a plurality of nodes in the wireless network into a Euclidean distance matrix (EDM);
decoding, by the electronic device, the EDM to generate a global topology for the plurality of nodes in the wireless network;
summing, by the electronic device and for each node in the plurality of nodes in the wireless network, events detected by each node in the plurality of nodes during a predetermined time period;
performing, by the electronic device, a kernel density filtering of the sums of the detected events over a two-dimensional space of the global topology;
calculating, by the electronic device, a product of Gaussian distributions calculated by the kernel density filtering; and
selecting the node that is spatially closest to a peak of the product of Gaussian distributions as the central node for event reporting.

2. The method of claim 1, wherein the decoding of the EDM comprises:
generating, by the electronic device, a geometric centering matrix;
generating, by the electronic device, a Gram matrix using the generated geometric centering matrix;
generating, by the electronic device, an eigenvalue decomposition of the generated Gram matrix; and
estimating, by the electronic device, the global topology from the generated eigenvalue decomposition.

3. The method of claim 1, wherein the ranges between the nodes are determined by round-robin ranging between the nodes in the plurality of nodes in the wireless network.

4. The method of claim 3, wherein the ranging is determined by measuring turn-around times between each pair of nodes in the wireless network.

5. The method of claim 4, wherein the nodes determine ranges by measuring turn-around times using IEEE 802.11.mc wireless communication or ultra-wideband wireless communication.

6. The method of claim 5, wherein the inserting of the determined ranges between the plurality of nodes into a Euclidean distance matrix (EDM) comprises:
inserting, by the electronic device, the measured turn-around times between the plurality of nodes into the EDM.

7. The method of claim 1, wherein the selecting the central node is effective to direct nodes in the wireless network to forward detected events to the central node, and wherein the central node forwards the events to a cloud service.

8. The method of claim 1, wherein the kernel for the kernel density filtering of the sums of the detected events is a Gaussian kernel.

9. The method of claim 1, wherein the electronic device is one of:
a server for a cloud service;
a border router;
a smartphone; or
a hub.

10. An apparatus comprising:
a processor; and
instructions executable by the processor to:
insert ranges between a plurality of nodes in a wireless network into a Euclidean distance matrix (EDM);
decode the EDM to generate a global topology for the plurality of nodes in the wireless network:
sum, for each node in the plurality of nodes in the wireless network, events detected by each node in the plurality of nodes during a predetermined time period;
perform a kernel density filtering of the sums of the detected events over a two-dimensional space of the global topology;
calculate a product of Gaussian distributions calculated by the kernel density filtering; and
select the node that is spatially closest to a peak of the product of Gaussian distributions as a central node for event reporting.

11. (canceled)

12. (canceled)

13. The apparatus of claim 10, wherein the instructions to decode the EDM are executable to:
generate a geometric centering matrix;
generate a Gram matrix using the generated geometric centering matrix;
generate an eigenvalue decomposition of the generated Gram matrix; and
estimate the global topology from the generated eigenvalue decomposition.

14. The apparatus of claim 10, wherein the ranges between the nodes are determined by round-robin ranging between the nodes in the plurality of nodes in the wireless network.

15. The apparatus of claim 14, wherein the ranging is determined by measuring turn-around times between each pair of nodes in the wireless network.

16. The apparatus of claim 15, wherein the nodes determine ranges by measuring turn-around times using IEEE 802.11.mc wireless communication or ultra-wideband wireless communication.

17. The apparatus of claim 16, wherein the instructions for the insertion of the determined ranges between the plurality of nodes into a Euclidean distance matrix (EDM) are executable to:
insert the measured turn-around times between the plurality of nodes into the EDM.

18. The apparatus of claim 10, wherein the selection of the central node is effective to direct nodes in the wireless network to forward detected events to the central node, and wherein the central node forwards the events to a cloud service.

19. The apparatus of claim 10, wherein the kernel for the kernel density filtering of the sums of the detected events is a Gaussian kernel.

20. The apparatus of claim 10, wherein the apparatus is one of:
a server for a cloud service;
a border router;
a smartphone; or
a hub.

21. A non-transitory computer-readable storage medium comprising instructions for an application, the instructions executable by one or more processors, to configure the application to:
insert ranges between a plurality of nodes in a wireless network into a Euclidean distance matrix (EDM);
decode the EDM to generate a global topology for the plurality of nodes in the wireless network;
sum, for each node in the plurality of nodes in the wireless network, events detected by each node in the plurality of nodes during a predetermined time period;
perform a kernel density filtering of the sums of the detected events over a two-dimensional space of the global topology;
calculate a product of Gaussian distributions calculated by the kernel density filtering; and
select the node that is spatially closest to a peak of the product of Gaussian distributions as a central node for event reporting.

22. A non-transitory computer-readable storage medium of claim 21, the instructions to decode the EDM executable by one or more processors, to configure the application to:
generate a geometric centering matrix;
generate a Gram matrix using the generated geometric centering matrix;
generate an eigenvalue decomposition of the generated Gram matrix; and
estimate the global topology from the generated eigenvalue decomposition.
